(19) United States
(12) Patent Application Publication
(10) Pub. No.: US 2008/0022201 A1
(43) Pub. Date: Jan. 24, 2008

(54) PERSONALIZED FINE GRANULARITY ACCESS CONTROL FOR CALENDAR SYSTEMS

(75) Inventors: Li Chen, Cary, NC (US); Yongcheng Li, Cary, NC (US); Lun Xiao, Cary, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/458,435

(22) Filed: Jul. 19, 2006

(51) Int. Cl. G06F 9/00; G06F 17/00

(52) U.S. Cl. 715/700; 715/764; 715/963

(57) ABSTRACT

Embodiments of the present invention address deficiencies of the art in respect to event exposure in a C&S system and provide a method, system and computer program product for personalized fine granularity access control for C&S systems. In one embodiment, a method for personalized fine granularity access control in a C&S data processing system can be provided. The method can include loading an event for inclusion in a shared calendar view, determining on a field by field basis whether to include portions of the event in the shared calendar view, and rendering the calendar view. The method further can include further determining whether the event has been marked private, and, if the event has been marked private, including in the shared calendar view only an indication that a private event has been scheduled without revealing content for the private event.

### BACKGROUND OF THE INVENTION

1. Field of the Invention

The present invention relates to the field of computer based calendaring and scheduling and more particularly to access control for viewing appointments in a calendaring and scheduling system.

2. Description of the Related Art

Calendaring systems have formed the core component of personal information management software and firmware applications for decades. Initially, a mere calendar display, modern calendaring systems provide scheduling and alarm functions in addition to full integration with contact management, time entry, billing and project management applications. The typical calendaring application minimally provides a mechanism for scheduling an event to occur on a certain date at a certain time. Generally, the event can be associated with a textual description of the event. More advanced implementations also permit the association of the scheduled event with a particular contact, a particular project, or both. Furthermore, most calendar applications provide functionality for setting an alarm prior to the occurrence of the event, as well as archival features.

Several software products include support for Calendaring & Scheduling (C&S). Known C&S products include Lotus Notes, Microsoft Outlook, and web-based products like Yahoo! Calendar. These products allow one to manage personal events including appointments and anniversaries. C&S products also typically allow one to manage shared events, referred to generally as meetings.

Within a C&S system, it is common to render public calendar entries such as appointments, events or meetings, viewable by other users of the C&S system. Notwithstanding, to ensure privacy, events or meetings marked private can be hidden from the view of others. Generally, users afforded access to view the calendar entries of another user can view all of the calendar entries of the other user. In this way, different users can locate “free time” for including a selection of users in a meeting. Yet, when an event or meeting has been rendered public, other users can view the entirety of the event or meeting including all event fields such as the identity of the attendants and the subject matter of the meeting.

For an end user to identify free time for another user, the end user at least must be able to view the existence of all scheduled events including private events. Otherwise, a private event will masquerade as free time. Yet, the privacy of the content of a private event cannot be compromised solely to expose the event as consuming free time. Likewise, even where a user is authorized to view the events of another user, it may be the intent that only certain portions of an event are to be exposed while others are to remain private. Notwithstanding, conventional C&S systems permit the binary choice only of exposing an event in its entirety, or hiding an event in it's entirety.

### BRIEF SUMMARY OF THE INVENTION

Embodiments of the present invention address deficiencies of the art in respect to event exposure in a C&S system and provide a novel and non-obvious method, system and computer program product for personalized fine granularity access control for C&S systems. In one embodiment, a method for personalized fine granularity access control in a C&S data processing system can be provided. The method can include loading an event for inclusion in a shared calendar view, determining on a field by field basis whether to include portions of the event in the shared calendar view, and rendering the calendar view. The method further can include further determining whether the event has been marked private, and, if the event has been marked private, including in the shared calendar view only an indication that a private event has been scheduled without revealing content for the private event.

In one aspect of the embodiment, determining on a field by field basis whether to include portions of the event in the shared calendar view can include identifying an end user requesting the shared calendar view, loading a set of field level access attributes for the event, comparing the end user to the field level access attributes to determine whether the identified end user is permitted to view the event on a field-by-field basis, and including in the calendar view only fields of the event permitted to be viewed by the identified end user.

In another aspect of the embodiment, determining on a field by field basis whether to include portions of the event in the shared calendar view can include suppressing an identity of a person associated with the event from display in the shared calendar view, and including in the shared calendar view a time range and type for the event. Finally, in yet another aspect of the embodiment, determining on a field by field basis whether to include portions of the event in the shared calendar view can include suppressing a description of the event from display in the shared calendar view, and including in the shared calendar view a time range and type for the event.

In another embodiment of the invention, a C&S data processing system can be provided. The C&S data processing system can include C&S core logic coupled to a data store of events, a C&S user interface, and access control logic. The access control logic can include program code enabled to determine whether to include portions of events in the data store of events in a shared calendar view of the C&S user interface on a field-by-field basis according to field level access attributes for the events. The program code of the access control logic further can be enabled to render an indication of a private event for an unauthorized viewer of the private event in lieu of suppressing the private event in its entirety.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a C&S system configured for personalized fine granularity access control;

FIG. 2 is a screen shot of an exemplary C&S system user interface configured for personalized fine granularity access control for C&S systems; and,

FIG. 3 is a flow chart illustrating a process for personalized fine granularity access control.

### DETAILED DESCRIPTION OF THE INVENTION

Embodiments of the present invention provide a method, system and computer program product for personalized fine granularity access control. In accordance with an embodiment of the present invention, access control attributes can be assigned to each field in an event. Thereafter, when sharing the event in the calendar view of different end users, the event can be rendered with some fields hidden from view according to the permissions of a viewing user, while other fields of the event can be rendered for view. Additionally, private events can be rendered only as a private event, while the content of the private events can remain hidden. In this way, private events cannot masquerade as free time and the privacy of selected content of a shared event can be maintained.

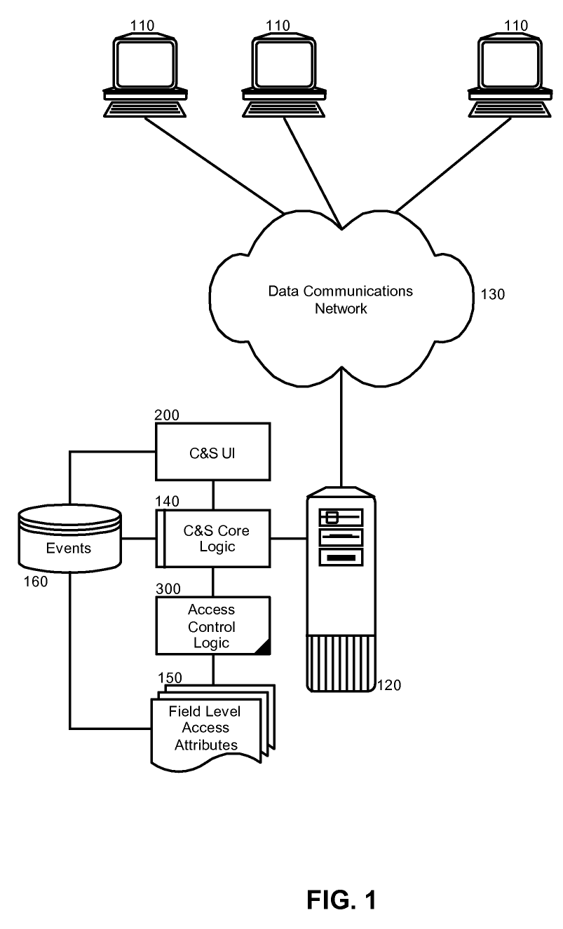

In more particular illustration, FIG. 1 is a schematic illustration of a C&S system configured for personalized fine granularity access control. The C&S system can include a host computing platform 120 supporting the operation of a C&S system. The host computing platform 120 can be configured for coupling over a data communications network 130 to one or more client computing devices 110 associated with corresponding end users of the C&S system. In this way, the different end users of the C&S system can interact with the C&S system in order to create, manage and view scheduled events for one another in a collaborative environment.

The C&S system can include C&S core logic 140 coupled to a data store of events 160 and a corresponding C&S user interface 200. The C&S core logic 140 can include program code enabled to provide essential calendaring functionality including the creation and management of scheduled events such as those events marked private and those events that are permitted to be viewed by other end users. Additionally, the C&S core logic 140 can be coupled to access control logic 300 for determining when to expose a view to different end users of different scheduled events in the data store of events 160, and when to refrain from exposing a view to different end users of different scheduled events in the data store of events 160.

Importantly, the access control logic 300 can include program code enabled to provide personalized, fine granularity access control to the events in the data store of events 160. To that end, the program code of the access control logic 300 can be enabled to determine access for a particular end user on a field-by-field basis as specified by field level access attributes 150 for each event in the data store of events 160. Consequently, when rendering a view of an event in the C&S user interface 200, only those fields determined to be viewable can be rendered in the C&S user interface 200. Additionally, so as to prevent a private event from masquerading as free time, the program code of the access control logic 300 can indicate in a view of the event in the C&S user interface 200 that a private event occurs during a specified time range without revealing the content of the private event.

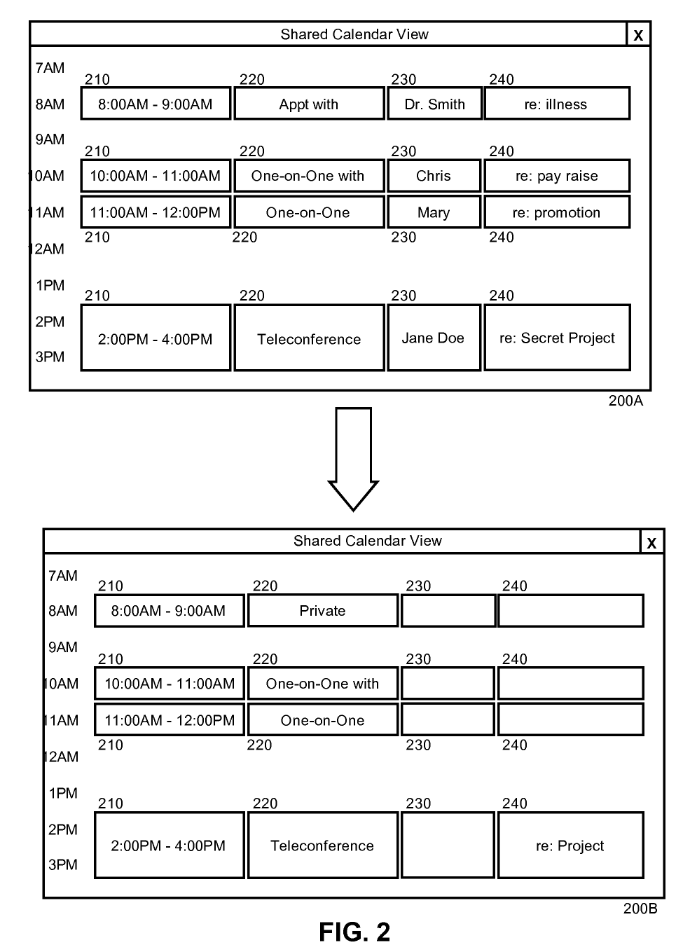

In further illustration of the view of events provided within the C&S user interface 200, FIG. 2 is a screen shot of an exemplary C&S system user interface configured for personalized fine granularity access control for C&S systems. The user interface 200 can provide a shared calendar view for multiple different end users of the C&S system. The shared calendar view can include one or more events rendered to indicate a time range of each event. Each event can include multiple different event fields 210, 220, 230, 240. The event fields can include a time range 210, an event type 220, an event person(s) or role(s) 230 and an event description 240. Other event fields can include subject, location, chairperson, and category, to name only a few.

As the field attributes are applied to each event in the shared calendar view, only certain fields of each event can be rendered viewable while others can be suppressed from view. Moreover, private events can show as private in the shared calendar view, though the content of the private events can be suppressed from view as shown in FIG. 2. In this way, scheduled events can be shown as consuming free time to other authorized end users, yet the privacy of a private event can be maintained. Likewise, the existence of a scheduled event can be shown, though portions of the event can remain private to only those end users authorized to view those private portions according to the field level attributes for the private portions and the identity of the end users viewing the events.

Notably, the access control for viewing events in a shared calendar view can be personalized according to the identity of a viewing end user, or a role of a viewing end user. In this regard, on a field-by-field basis, each field can be assigned a field level access attribute indicating whether the field is to be viewed by an authorized user, user type or role. When an end user attempts to view the field, the field will be revealed only if the identity of the end user or role of the end user matches the field level access attribute. Furthermore, the content of a field may vary according to the identity of the viewing end user or the role of the viewing end user. For instance, whereas one end user may view a field to read “re: Secret Project”, another end user may only view a field to read “re: Project”.

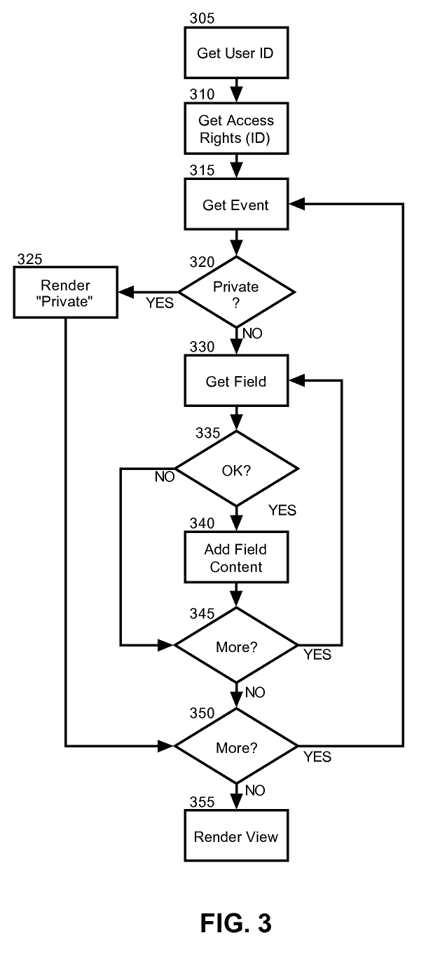

In yet further illustration, FIG. 3 is a flow chart illustrating a process for personalized fine granularity access control. Beginning in block 305, a user identifier for an end user of the C&S system can be obtained as can access rights for the end user in block 310. In block 315, a first event can be retrieved from the event database for rendering in the shared calendar view for the end user. In decision block 320, it can be determined if the event has been marked private. If so, in block 325 the event can be included in the shared calendar view for the specified time range only as a “private” event while the content of the private event can remain hidden. Of course, if the event is private to the end user associated with the user identifier, then the entirety of the private event can be included for view in the shared calendar view.

In decision block 320, if the event has not been marked private, in block 330, a first field in the event can be retrieved for processing. In decision block 335, if the field has field attributes permitting the rendering of the field for viewing by the end user, in block 340 the content of the field can be included in the shared calendar view. In decision block 345, if additional fields remain to be processed, in block 330 a next field can be retrieved and the process can repeat through decision block 335. When no further fields remain to be processed for the event, in decision block 350 it can be determined if additional events remain to be processed. If so, in block 315 a next event can be retrieved and the process can continue through decision block 320. Otherwise, the shared calendar view can be rendered in block 355.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for personalized fine granularity access control in a calendaring and scheduling (C&S) system, the method comprising:
loading an event for inclusion in a shared calendar view;
determining on a field by field basis whether to include portions of the event in the shared calendar view; and,
rendering the calendar view.

2. The method of claim 1, further comprising:
further determining whether the event has been marked private; and,
if the event has been marked private, including in the shared calendar view only an indication that a private event has been scheduled without revealing content for the private event.

3. The method of claim 1, wherein determining on a field by field basis whether to include portions of the event in the shared calendar view, comprises:
identifying an end user requesting the shared calendar view;
loading a set of field level access attributes for the event;
comparing the end user to the field level access attributes to determine whether the identified end user is permitted to view the event on a field-by-field basis; and,
including in the calendar view only fields of the event permitted to be viewed by the identified end user.

4. The method of claim 1, wherein determining on a field by field basis whether to include portions of the event in the shared calendar view, comprises:
suppressing an identity of a person associated with the event from display in the shared calendar view; and,
including in the shared calendar view a time range and type for the event.

5. The method of claim 1, wherein determining on a field by field basis whether to include portions of the event in the shared calendar view, comprises:
suppressing an description of the event from display in the shared calendar view; and,
including in the shared calendar view a time range and type for the event.

6. The method of claim 3, wherein comparing the end user to the field level access attributes to determine whether the identified end user is permitted to view the event on a field-by-field basis, comprises comparing an identity of the end user to a field level access attribute for each corresponding field to determine whether the end user is permitted to view each corresponding field of the event.

7. The method of claim 3, wherein comparing the end user to the field level access attributes to determine whether the identified end user is permitted to view the event on a field-by-field basis, comprises comparing a role of the end user to a field level access attribute for each corresponding field to determine whether the end user has a role permitted to view each corresponding field of the event.

8. The method of claim 3, further comprising further comparing a role of the end user to a field level access attribute for each corresponding field to determine content to be viewed within each corresponding field of the event.

9. A calendaring and scheduling (C&S) data processing system comprising:
C&S core logic coupled to a data store of events;
a C&S user interface; and,
access control logic comprising program code enabled to determine whether to include portions of events in the data store of events in a shared calendar view of the C&S user interface on a field-by-field basis according to field level access attributes for the events.

10. The C&S data processing system of claim 9, wherein the events comprise fields selected from the group consisting of event time range, event type, event participant, subject, location, chair, category and event description.

11. The C&S data processing system of claim 9, wherein the program code of the access control logic is further enabled to render an indication of a private event for an unauthorized viewer of the private event in lieu of suppressing the private event in its entirety.

12. A computer program product comprising a computer usable medium embodying computer usable program code for personalized fine granularity access control of events in a calendaring and scheduling (C&S) system, the computer program product including:
computer usable program code for loading an event for inclusion in a shared calendar view;
computer usable program code for determining on a field by field basis whether to include portions of the event in the shared calendar view; and,
computer usable program code for rendering the calendar view.

13. The computer program product of claim 12, further comprising:
computer usable program code for further determining whether the event has been marked private; and,
computer usable program code for including in the shared calendar view only an indication that a private event has been scheduled without revealing content for the private event if the event has been marked private.

14. The computer program product of claim 12, wherein the computer usable program code for determining on a field by field basis whether to include portions of the event in the shared calendar view, comprises:
computer usable program code for identifying an end user requesting the shared calendar view;
computer usable program code for loading a set of field level access attributes for the event;
computer usable program code for comparing the end user to the field level access attributes to determine whether the identified end user is permitted to view the event on a field-by-field basis; and,
computer usable program code for including in the calendar view only fields of the event permitted to be viewed by the identified end user.

15. The computer program product of claim 12, wherein the computer usable program code for determining on a field by field basis whether to include portions of the event in the shared calendar view, comprises:
computer usable program code for suppressing an identity of a person associated with the event from display in the shared calendar view; and,
computer usable program code for including in the shared calendar view a time range and type for the event.

16. The computer program product of claim 12, wherein the computer usable program code for determining on a field by field basis whether to include portions of the event in the shared calendar view, comprises:
computer usable program code for suppressing an description of the event from display in the shared calendar view; and,
computer usable program code for including in the shared calendar view a time range and type for the event.

17. The computer program product of claim 14, wherein the computer usable program code for comparing the end user to the field level access attributes to determine whether the identified end user is permitted to view the event on a field-by-field basis, comprises computer usable program code for comparing an identity of the end user to a field level access attribute for each corresponding field to determine whether the end user is permitted to view each corresponding field of the event.

18. The computer program product of claim 14, wherein the computer usable program code for comparing the end user to the field level access attributes to determine whether the identified end user is permitted to view the event on a field-by-field basis, comprises computer usable program code for comparing a role of the end user to a field level access attribute for each corresponding field to determine whether the end user has a role permitted to view each corresponding field of the event.

19. The computer program product of claim 12, further comprising computer usable program code for further comparing a role of the end user to a field level access attribute for each corresponding field to determine content to be viewed within each corresponding field of the event.
